(19) United States
(12) Patent Application Publication
(10) Pub. No.: US 2008/0212530 A1
(43) Pub. Date: Sep. 4, 2008

(54) APPARATUS AND METHOD FOR FREQUENCY REUSE IN A MULTI INPUT MULTI OUTPUT SYSTEM

(75) Inventors: Elisabeth de CARVALHO, Aalborg (DK); Muhammad Imadur Rahman, Aalborg (DK); Hak-Ju Lee, Bupyeong-gu (KR); David Mazzarese, Suwon-si (KR); Chi-Woo Lim, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/040,361

(22) Filed: Feb. 29, 2008

(30) Foreign Application Priority Data
Mar. 2, 2007 (KR) 2007-0020788

(51) Int. Cl. H04Q 7/00

(52) U.S. Cl. 370/329

(57) ABSTRACT

A frequency reuse apparatus and method for a Mobile Station (MS) using a multiple-antenna in a broadband wireless access communication system are provided. The method includes dividing a first frequency band into ‘N’ second frequency bands where ‘N’ equals a number of Base Stations (BSs); dividing each second frequency band into ‘n’ third frequency bands; allocating each of the ‘N’ second frequency bands according to the number of receive antennas; and allocating the third frequency bands to all of the BSs, respectively.

### PRIORITY

This application claims priority under 35 U.S.C. §119(a) of to Korean patent application filed in the Korean Intellectual Property Office on Mar. 2, 2007 and assigned Serial No. 2007-20788, the entire disclosure of which is hereby incorporated by reference.

### BACKGROUND OF THE INVENTION

1. Field of the Invention

The present invention relates generally to frequency allocation for frequency reuse, and in particular, to an allocation apparatus and method for efficient frequency reuse in downlink in a Multi Input Multi Output (MIMO)-Orthogonal Frequency Division Multiple Access (OFDMA) broadband wireless access communication system.

2. Description of the Related Art

With an increasing demand for frequency reuse, new methods for utilizing available frequency bands are of great importance. One of the main concerns for designing frequency channel assignment at a cell edge is the number of available receive-antennas of a receiver subjected to interference. It has been previously reported that the maximum number of streams (both desired and interfering streams) that a receiver can resolve using linear receive techniques is equal to the number of receive antennas. The number of interfering streams can be equated to the number of interfering logical streams. The interfering logical streams are defined as interfering data streams. Under this definition, receive diversity, transmit antenna selection, or transmit beamforming (TxBF) links are referred to as a single-link logical stream.

When Space Time Block Coding (STBC) is used at an interfering link, then the link experiences more than one apparent logical stream if signals are processed on a symbol-by-symbol basis. A linear Minimum Mean Square Error (MMSE) receiver based on multi-symbol processing cancels out the interferers, provided that the number of receive antennas is greater than or equal to the number of received logical streams (including desired and interfering streams). This multiple-symbol based receiver technique demonstrates robustness against any single stream interferer.

A Fractional Frequency Reuse (FFR) technology for severely Co-Channel Interference (CCI) affected Mobile Stations (MSs) at the cell edge assigns frequency channels to any particular MS based on the location of the particular MS. Usable frequency channel sets for all MSs in a cell are defined for MSs located inside the cell area (i.e., much closer compared to cell edge).

When an MS is located around a cell edge, then frequency allocation also should take care of the nearest CCI source, i.e. the nearest Base Station (BS) that is also transmitting in downlink. Therefore, based on information about the location of any MS at the cell edge, a decision regarding an available frequency set for a particular MS is made.

When interference rejection capabilities using MIMO technologies are not taken into account in an FFR design, it is clear that the benefit of MIMO communication systems will not be exploited in the frequency assignment.

The performance of the system can be greatly improved when MIMO interference cancellation capabilities are taken into account for frequency reuse assignments. Therefore, an apparatus and method for frequency allocation for FFR using the MIMO interference cancellation capabilities are needed.

### SUMMARY OF THE INVENTION

An object of the present invention is to address at least the above problems and/or disadvantages and to provide at least the advantages described below. Accordingly, an object of the present invention is to provide an apparatus and method for frequency reuse in an MIMO system.

Another object of the present invention is to provide an allocation apparatus and method for efficient frequency reuse in an MIMO downlink in an OFDMA broadband wireless access communication system.

The above aspects are achieved by providing an apparatus and method for frequency reuse in a multi input multi output system.

According to one embodiment of the present invention, a frequency reuse method for a Mobile Station (MS) using a multiple-antenna in a broadband wireless access communication system is provided. The method includes dividing a first frequency band into ‘N’ second frequency bands where ‘N’ equals a number of Base Stations (BSs); dividing each second frequency band into ‘n’ third frequency bands, wherein ‘n’ is a natural number; allocating each of the ‘N’ second frequency bands according to a number of receive antennas of the MS; and allocating each of the third frequency bands to all of the BSs, respectively.

According to another embodiment of the present invention, an apparatus for deciding a frequency reuse method for an MS using a multiple-antenna in a broadband wireless access communication system is provided. The apparatus includes a communication module for communicating with another node; a controller for transmitting a control message instructing a frequency sharing degree through the communication module, dividing, when there are ‘N’ Base Stations (BSs), a first frequency band into ‘N’ second frequency bands, dividing each second frequency band into ‘n’ third frequency bands, allocating each of the ‘N’ second frequency bands according to a number of receive antennas of the MS, and allocating each of the third frequency bands to all of the BSs, respectively; and a storage unit for storing necessary data by the controller, wherein ‘n’ is a natural number.

### BRIEF DESCRIPTION OF THE DRAWINGS

The above and other aspects, features and advantages of certain exemplary embodiments of the present invention will become more apparent from the following detailed description when taken in conjunction with the accompanying drawings in which:

FIG. 1 is a diagram illustrating network architecture according to an exemplary embodiment of the present invention;

FIG. 2 is a graph illustrating an example of frequency allocation according to an exemplary embodiment of the present invention;

FIG. 3 is a block diagram illustrating an apparatus according to an exemplary embodiment of the present invention; and

FIG. 4 is a flow diagram illustrating a frequency allocation process according to an exemplary embodiment of the present invention.

Throughout the drawings, it should be noted that like reference numbers are used to depict the same or similar elements, features, and structures.

### DETAILED DESCRIPTION OF EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

A description of an apparatus and method for frequency reuse in an MIMO system according to the present invention is made below. The present invention proposes a novel frequency assignment technique among the cell edge MSs that exploit knowledge of the number of available receive antennas and the multiple-symbol based linear MMSE technique.

Each cell is assigned one set of frequencies for cell-edge MSs. The frequencies are shared among MSs of different interference rejection capabilities. Orthogonal frequency channels are used across the cells only for the cell-edge MSs, thus a fractional re-use factor is achieved.

The present invention is not only adapted to the number of interfering Base Stations (BSs), but to the total number of transmitted logical streams. This may be done at cell site deployment, or adaptively over time with cooperation from cell sites.

A FFR method of the present invention does not take care of the impact of the type of interferer; rather the method only concentrates on the fact that multiple CCI interferers are present for a cell edge MS.

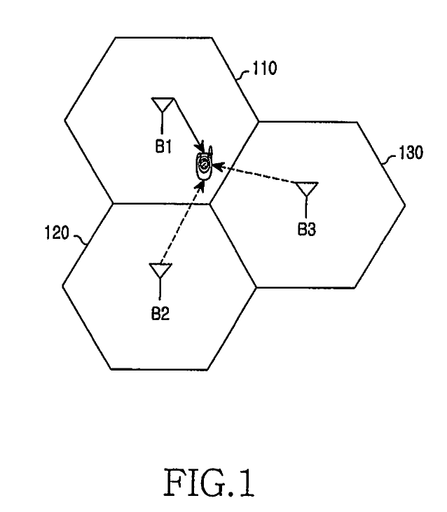

FIG. 1 is a diagram illustrating network architecture according to an exemplary embodiment of the present invention.

In FIG. 1, the number of receive antenna of an MS is defined as ‘Q’ and the number of downlink interferers is defined as ‘I’. As mentioned earlier, a linear MMSE receiver can cancel out at least Q-1 number of interferers. This is true even for the case when STBC is present as interferer. To satisfy this condition (i.e., achieve enough diversity required to null out the interferers) and exploit multiple-symbol processing, the present invention proposes frequency sharing between main interfering BSs 120 and 130. The main assumptions are:

1. There are two main interfering BSs 120 and 130, as shown in FIG. 1: the other interfering BSs are assumed negligible. The present invention is also intended to include more interfering BSs.

2. A frequency band is reserved for MSs located at cell edge and shared by the interfering BSs 120 and 130. Each BS does not know the nature of the interfering links.

3. Spatial Multiplexing is not used for transmission to cell edge MSs. Only single logical link transmission is used.

4. The MS knows the maximum length of STBC codes used by the interfering BSs 120 and 130: this assumption is not strictly necessary as the MS could estimate the maximum length.

5. STBC transmissions are synchronized for all the BSs (i.e., start at same time for all BSs).

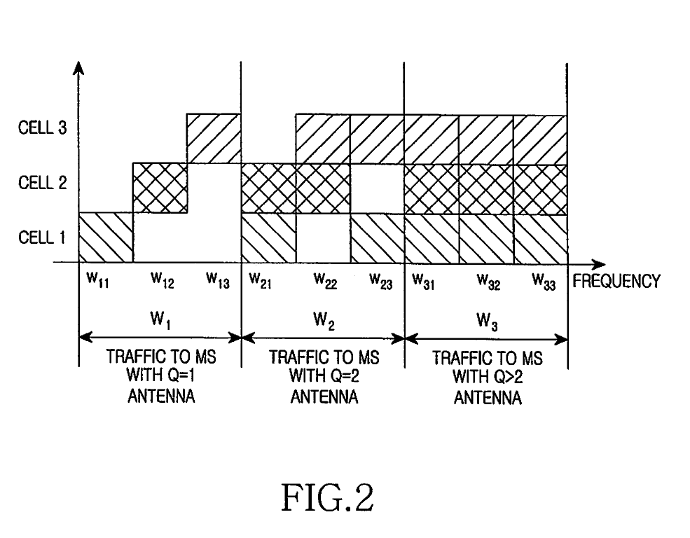

FIG. 2 is a graph illustrating an example of frequency allocation according to an exemplary embodiment of the present invention.

In FIG. 2, the basic principle of a frequency reuse technology of the present invention is as follows:

For Q=1, no frequency sharing is allowed, as an MS cannot nullify any interfering signal. For Q=2, frequency sharing between two BSs is allowed, because an MS can now efficiently nullify one interfering signal. For Q≧3, frequency sharing between two or more BSs is allowed.

Transmission towards one MS during downlink can cause interference for other MSs. In another words, assigning some resources to any MS located in cell edge area can also mean that some interference is generated for other MSs located at the neighboring cells. Thus, the existence of one particular MS can result in interference for other MSs. With the knowledge of the interference rejection capability, unwanted interference can be avoided for other users in the neighboring cells.

The channel assignment technology of the present invention can avoid interferences from other interfering BSs and also to ensure that one particular MS does not become source of interference for others.

Assuming that the total available frequency sets for all three BSs is denoted as ‘W’, three disjoint sets of frequencies are defined as follows:

1. W₁, W₂ and W₃⊂W

2. Wᵢ#Wⱼ=Ø, where Ø means an empty set, for i, jε{1,2,3}.

3. MSs located inside a cell area of all cells can use the same frequency band. The frequency band can be denoted as

$$W ⋂ ( {{⋃}_{i = 1}}^{3} {W}_{i} ) .$$

That is, when there are three BSs, three frequency sets are generated. These three frequency bands are identified by three classes, respectively. The classes are, as mentioned before, with respect to the number of available receive antennas at a corresponding MS. For the example shown in FIGS. 1 and 2, there are three different cells and the frequencies in all of three bands mentioned above are allocated to one class.

Thus, another three sub-sets of frequencies under all the above three frequency sets are defined as follows:

1. Wᵢ₁∪Wᵢ₂∪Wᵢ₃=Wᵢ

2. Wᵢₓ∩W_{iy}=Ø, for all i,x, yε{1,2,3}

As shown in FIG. 2, the assignment scheme of the present invention assumes that an MS always has sufficient capabilities to nullify interfering signals. The frequency allocation principle can be described as follows:

1. MSs with Q=1 antennas are scheduled in a frequency band W₁ where no frequency sharing between BSs is allowed.

2. MSs with Q=2 antennas are scheduled in a frequency band W2 where frequency sharing between two BSs is allowed.

3. MSs with Q≧3 antennas are scheduled in a frequency band W3 where frequency sharing between three BSs is allowed.

The sizes of these frequency sets and subsets depend on the number of available MSs located at cell edge with certain receive antenna classes. As the load factor for all these three classes is always random (or at least not deterministic), W₁, W₂ and W₃ (and sub-channel bandwidth inside each band) must be adapted.

Frequency hopping can be used to reassign particular frequency bands and subbands. The sharing is described in FIG. 2 in frequency only, but sharing can occur over time or in a time-frequency plane or both.

The above process is generalized as follows:

If there are ‘N’ BSs, a constant frequency band (hereinafter, referred to as “First Band”) is divided into ‘N’ frequency bands. Each of the frequency bands resulting from the division of the First Band is referred to as a “Second Band,” i.e., there are ‘N’ second bands. Then, each second band is again divided into ‘n’ frequency bands. Each of the frequency bands resulting from the division by ‘n’ is referred to as a “Third Band.” Here, ‘N’ and ‘n’ are the same in size.

Then, it is set to allocate the second bands according to the number of receive antennas of an MS. That is, a first frequency band is set to be allocated to an MS having one receive antenna and in sequence, it is set to allocate an N-th frequency band to an MS having ‘N’ or more receive antennas.

Then, the third bands are allocated to all BSs (the number of BSs is ‘n’), respectively, i.e., the second band is divided into ‘n’ third bands since the ‘n’ is equal to the number of BSs. It is allowed to allocate each of the third bands to each of the BSs.

Then, it is allowed for a BS not to share a 1^{st} second frequency band of the second bands, because an MS has no ability to cancel out an interferer due to having one receive antenna.

Then, two BSs can share one of the third bands with each other since a 2^{nd} second band of the second bands is allocated to an MS having two receive antennas, because the MS can cancel out one interferer due to having the two receive antennas.

Three BSs can share one of the third bands with each other since a 3^{rd} second band of the second bands is allocated to an MS having three receive antennas, because the MS can cancel out two interferers due to having the three receive antennas.

‘N’ BSs can share one of the third bands with each other since an N-th second band of the second band is allocated to an MS having ‘N’ receive antennas. This is because the MS can cancel out (N-1) interferers due to having the ‘N’ receive antennas.

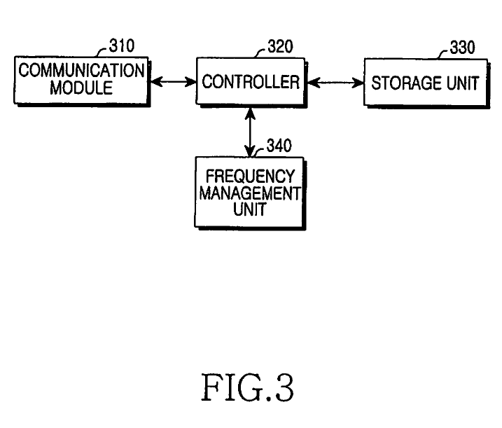

FIG. 3 is a block diagram illustrating an apparatus according to an exemplary embodiment of the present invention.

The apparatus includes a communication module 310, a controller 320, a storage unit 330, and a frequency management unit 340.

The communication module 310, a module for communicating with another node, includes a wireless processing module, a wired processing module, and a baseband processing module (not shown). The wireless processing module converts a signal received through an antenna into a baseband signal and provides the baseband signal to the baseband module. The wireless processing module converts a baseband signal from the baseband module into a Radio Frequency (RF) signal for actual transmission over the air and transmits the RF signal through the antenna. The wired processing module converts a signal received via a wired path into a baseband signal and provides the baseband signal to the baseband module. The wired processing module converts a baseband signal from the baseband module into a corresponding wired signal for actual transmission on a wired line and transmits the wired signal via a connected wired path.

The controller 320 performs basic processing and control of the apparatus. For example, the controller 320 performs processing and control for voice communication and data communication and in addition to a general function, controls the frequency management unit 340 to decide a frequency sharing degree and receives and transmits the result to a corresponding node according to the present invention.

The storage unit 330 stores a program for controlling general operation of the apparatus and temporary data generated during program execution.

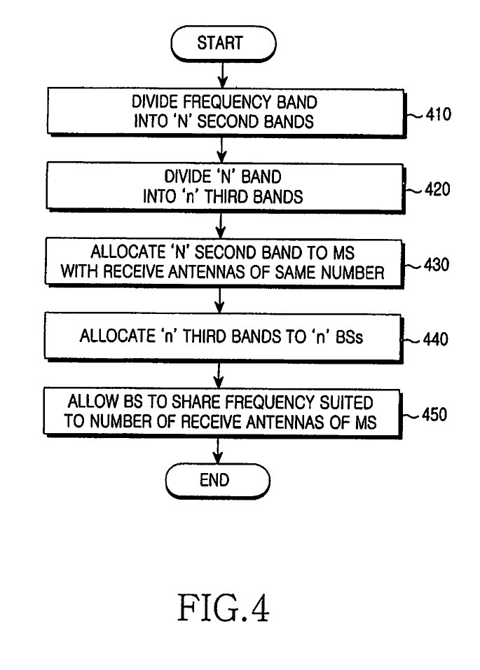

The frequency management unit 340 divides a constant frequency band into a second band and a third band according to instruction and information provision by the controller 320 and enables a BS to share the second band and the third band according to the number of BSs and the number of receive antennas of an MS. That is, the frequency management unit 340 performs a frequency allocation process described above. The frequency allocation process is described later with reference to a flow diagram of FIG. 4.

The controller 320 can perform a function of the frequency management unit 340. The present invention separately constructs and shows constituent elements in order to distinguish and describe respective functions of the constituent elements. The controller 320 can be constructed to process all or some of the functions of the frequency management unit 340.

FIG. 4 is a flow diagram illustrating a frequency allocation process according to an exemplary embodiment of the present invention. “N” and “n” denote natural numbers and are equal to each other.

In FIG. 4, the apparatus of the present invention divides a frequency band into ‘N’ second bands in step 410. Then, the apparatus divides each of the ‘N’ second bands into ‘n’ third bands in step 420. After that, the apparatus allocates the ‘N’ second bands for an MS having the same number of receive antennas in step 430. Then, the apparatus allocates the ‘n’ third bands to ‘n’ BSs in step 440. Then, the apparatus allows a BS to share a frequency suited to the number of receive antennas of an MS in step 450 and then terminates the process according to the exemplary embodiment of present invention.

A frequency reuse technique of the present invention has an advantage of the ability to improve frequency reuse capabilities by allowing a BS to share a frequency in such a manner that an MS supporting an MIMO technology can cancel out interference.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A frequency reuse method for a Mobile Station (MS) using a multiple-antenna in a broadband wireless access communication system, comprising:
dividing a first frequency band into ‘N’ second frequency bands, where ‘N’ equals a number of Base Stations (BSs);
dividing each second frequency band into ‘n’ third frequency bands, wherein ‘n’ is a natural number;
allocating each of the ‘N’ second frequency bands according to a number of receive antennas of the MS; and
allocating each of the third frequency bands to all of the BSs.

2. The method of claim 1, further comprising:
determining any BS not to share one of the n third frequency bands in a 1^{st} second frequency band of the N second frequency bands; and
determining two BSs to share one of the n third frequency bands in a 2^{nd} second frequency band of the N second frequency bands;
determining three BSs to share one of the n third frequency bands in a 3^{rd} second frequency band of the N second frequency bands.

3. The method of claim 2, further comprising;
determining N BSs to share one of the n third frequency bands in an N^{th} second frequency band of the N second frequency bands.

4. The method of claim 3, wherein ‘N’ and ‘n’ are natural numbers, are equal to each other and are equal to a total number of BSs.

5. The method of claim 3, wherein the MS comprises ‘N’ or fewer antennas.

6. An apparatus for deciding a frequency reuse method for a Mobile Station (MS) using a multiple-antenna in a broadband wireless access communication system, comprising:
a communication module for communicating with another node;
a controller for transmitting a control message instructing a frequency sharing degree through the communication module, dividing, when there are ‘N’ Base Stations (BSs), a first frequency band into ‘N’ second frequency bands, dividing each second frequency band into ‘n’ third frequency bands, allocating each of the ‘N’ second frequency bands according to a number of receive antennas of the MS, and allocating each of the third frequency bands to all of the BSs, wherein ‘n’ is a natural number; and
a storage unit for storing data by the controller.

7. The apparatus of claim 6, wherein the controller determines any BS not to share one of the n third frequency bands in the 1^{st} second frequency band of the N second frequency bands, the controller determines two BSs to share one of the n third frequency bands in the 2^{nd} second frequency band of the N second frequency bands, and the controller determines three BSs to share one of the n third frequency bands in the 3^{rd} second frequency band of the N second frequency bands.

8. The apparatus of claim 7, wherein the controller determines N BSs to share one of the n third frequency bands in the N^{th} second frequency band of the N second frequency bands.

9. The apparatus of claim 8, wherein the ‘N’ and the ‘n’ are natural numbers, are equal to each other, and are equal to the total number of BSs.

10. The apparatus of claim 8, wherein the MS comprises ‘N’ or fewer antennas.
